(19) United States
(12) Patent Application Publication
(10) Pub. No.: US 2025/0269565 A1
(43) Pub. Date: Aug. 28, 2025

(54) Metal Material and Use Thereof in Preparing Metal Model

(71) Applicant: Taizhou Zhenhao Technology Co.,Ltd., Zhejiang (CN)

(72) Inventor: Ping HE, Zhejiang (CN)

(73) Assignee: Taizhou Zhenhao Technology Co.,Ltd., Zhejiang (CN)

(21) Appl. No.: 18/590,376

(22) Filed: Feb. 28, 2024

(51) Int. Cl. B29C 33/38; B29L 31/48; C23C 4/134; C23C 22/24; C23C 22/78; C25D 3/04; C25D 3/12; C25D 5/48

(52) U.S. Cl. CPC B29C 33/3892; C23C 4/134; C23C 22/24; C23C 22/78; C25D 3/04; C25D 3/12; C25D 5/48; B29K 2905/12; B29L 2031/4864

(57) ABSTRACT

The present invention provides a metal material and use thereof in preparing a metal model. The metal material comprises the following ingredients in percentage by weight: C≤0.06%, Si≤1.00%, 1.00%≤Mn≤4.00%, P≤0.045%, S≤0.005%, 20.00%≤Cr≤22.00%, 8.50%≤Ni≤10.50%, 1.00%≤Mos2.50%, 1.00%≤Cu≤3.50%, 0.20%≤N≤0.30%, with the balance being Fe; the pitting resistance equivalent number (PREN) of the metal material is calculated according to the formula: PREN=Cr %+3.3M0%+16N %, and the result is PREN≥30.0%

### TECHNICAL FIELD

The present invention relates to the technical field of metal materials, in particular to a metal material and use thereof in preparing a metal model.

### BACKGROUND

Nitrile products are mainly made of nitrile rubber, and their applications include medical treatment, hygiene, medical beauty, food processing, chemical industry, etc., which play the roles of isolation, protection and prevention of infection. Nitrile rubber does not contain protein, which will not cause allergic reaction to human body. It has antistatic, aging-resistant and oil-resistant properties, easy molding, flexible modeling, wide applicability and great flexibility, and at the same time it has high stretchability and penetration resistance, tensile strength and wear resistance.

The manufacturing process of nitrile film products includes nitrile impregnation, molding, vulcanization, surface treatment, dust-free cleaning and so on. Nitrile impregnation process includes pickling, alkali washing, chlorine washing, rinsing and drying the model. Then, the model was immersed in coagulant solution and latex liquefied raw materials in turn, and then the nitrile film layer impregnated on the model was cured and vulcanized, and finally the nitrile product was obtained by demoulding. The temperature range of the model immersed in the coagulant solution is 60-80° C., the temperature of the model immersed in the latex liquefied raw material is 20-60° C., and the curing and vulcanization temperature is 120-130° C. In addition, the model is washed with nitric acid and other liquids, neutralized with sodium hydroxide and other liquids, and finally rinsed with chlorine water for 20-30 minutes.

Therefore, the model for preparing NBR latex products needs acid and alkali resistance, good corrosion resistance, oxidation resistance, rust resistance, and stable thermal shock resistance during cold and hot conversion. In addition, the model also needs to have the uniformity and consistency of liquid NBR and latex coating, and also has good demoulding ability of NBR latex after curing and vulcanization.

Most of the existing models for NBR production are ceramic models, which belong to high-silica ceramic hand models, and have the following shortcomings: 1) the product production qualification rate is low, which is about 85%; 2) the total shrinkage rate of the product is high, which is 13-18%; 3) the product surface is uneven, with black spots, etc. 4) the service time is short, and the online service life of the ceramic model produced by the prior art in the production of nitrile rubber gloves is generally 3-8 months; 5) the thermal shock resistance is not strong; 6) the dimensional accuracy of the ceramic model is poor, and the wall thickness is too thick, which is generally 4-8 mm; 7) ceramics have poor thermal conductivity and slow heating and cooling, resulting in excessive heat energy loss in on-line production; 8) the model is heavy.

Therefore, it is necessary to find more suitable materials to prepare the model for NBR production.

### SUMMARY

In view of the shortcomings of the existing NBR latex ceramic model, the present invention provides a metal material and use thereof in preparing a metal model.

In order to solve the technical problems, the technical solution adopted by the present invention is as follows:

In a first aspect, the present invention provides a metal material, which includes the following ingredients in percentage by weight: C<0.06%, Si≤1.00%, 1.00%<Mn<4.00%, P≤0.045%, S≤0.005%, 20.00%≤Cr≤22.00%, 8.50%≤Ni≤10.50%, 1.00%≤Mo≤2.50%, 1.00%<Cu≤3.50%, 0.20%≤N<0.30%, with the balance being Fe; a pitting resistance equivalent number (PREN) of the metal material is calculated according to a formula: PREN=Cr %+3.3M0%+16N %, and a result is PREN>30.0%.

In a second aspect, the present invention provides use of the metal material in preparing a metal model.

In a third aspect, the present invention provides a method for preparing a metal model including a palm, an arm and a base, wherein the method comprises: preparing the palm, the arm and the base separately to obtain models of the palm, the arm and the base, and then connecting the models of the palm, the arm and the base to realize preparation of the metal model.

Preferably, the method includes the following steps:
Step 1, compounding the ingredients of the metal material according to claim 1 to prepare a metal coil, cutting the metal coil into sheets, and respectively forming the sheets into single-piece palm models and an arm model by stamping and stretching; and
Step 2, connecting two pieces of the single-piece palm models in a welding mode to form a complete palm model; and
Step 3, connecting the complete palm model and the arm model by welding; and
Step 4, connecting the base with the model obtained in step 3 by welding to form an integral model; and
Step 5, processing the palm part of the integral model to form a pitted surface; and
Step 6, carrying out surface treatment on the integral model with the pitted surface to form an anti-corrosion and wear-resistant layer.

Preferably, the base is made of SUS430.

Preferably, the pitted surface comprises a rough pitted surface or a fine pitted surface, and the pitted surface is formed by a pressurized pitting process or an etching process.

Preferably, a pit size of the rough pitted surface is 0.5 mm to 3.0 mm, and a pit size of the fine pitted surface is 0.1 to 1.0 mm.

Preferably, the pitted surface is only located at finger tips of the palm.

Preferably, the pitted surface is the whole palm part.

Preferably, the method further includes: after processing the pitted surface of the palm model, carrying out sand blasting treatment on the obtained integral model, preferably, using 60-150 mesh sand.

Preferably, an anti-corrosion and wear-resistant layer is formed on the surface of the integral model by one of the following methods: passivation, immersion, spraying and electroplating; and a thickness of the anti-corrosion and wear-resistant lay is 0.01 mm to 0.12 mm.

Preferably, a final concentration composition of a passivation solution adopted in the passivation is: magnesium chloride, 30-40 g/L; and
sodium chromate, 40-50 g/L, and water as solvent; and
before passivation, the metal model is washed with a pickling solution; and
the pickling solution adopts at least one of 30-40% nitric acid solution, 10-15% hydrofluoric acid solution and 10-15% sulfuric acid solution by mass concentration.

Preferably, a reagent used in the infiltration is nano-ceramic coating; and
a working temperature of an infiltration process is 15-30° C.

Preferably, the spraying is plasma spraying, and an anti-corrosion material adopted is one of nickel, nickel alloy, chromium and chromium alloy.

Preferably, the method further includes: the electroplating method being specifically nickel plating or chromium plating.

Preferably, the method further includes: after forming the integral model in step 4, grinding and polishing a patchwork seam of the integral model and trimming a port of a base part to make the port of the base part present a flat and consistent state.

Preferably, the welding is laser welding.

The present invention has the following technical effects:

The metal model prepared by adopting the metal material of the present invention has long online service life and strong acid and alkali corrosion resistance, and the performances of chloride ion such as pitting corrosion resistance, stress corrosion resistance, corrosion fatigue resistance and the like are obviously improved compared with the existing ceramic model. In addition, the metal model has the advantages of good thermal shock resistance, light weight, good dipping property, easy demoulding, good thermal conductivity and low energy consumption in product production. Further, the NBR latex gloves prepared by adopting the metal model of the present invention have the characteristics of skid resistance, strong wear resistance and low shrinkage. At the same time, it also solves the industrial difficulties of pitting corrosion, local corrosion and stress corrosion of chloride ions on general stainless steel.

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

### BRIEF DESCRIPTION OF DRAWINGS

In order to explain the technical scheme of this application more clearly, the drawings needed in the implementation will be briefly introduced below. Obviously, the drawings described below are only some implementations of this application. For those skilled in the art, other drawings can be obtained according to these drawings without creative work.

FIG. 1 is an effect diagram of the pitted surface of the finger tip of the metal model in Example 1 of the present invention.

FIG. 2 is an effect diagram of the pitted surface of the metal model arm in Example 2.

FIG. 3 is a schematic structural diagram of the metal model obtained in Example 1 of the present invention, and the fingers are rough pitted surfaces.

FIG. 4 is a schematic structural diagram of the metal model obtained in Example 2 of the present invention, with the rough pitted surface on the palm and fine pitted surface on the arm.

FIG. 5 is a schematic structural diagram of the metal model obtained in Example 3 of the present invention, in which the fingers are rough pitted surfaces, and the remaining palms and arms are fine pitted surfaces.

FIG. 6 shows the surface enlargement effect of the interface between palm and finger, the anti-corrosion coating on palm part and the pitted surface of finger part of the metal model in Example 1 of the present invention, wherein, FIG. A shows the surface shape of the interface between palm and finger; FIG. b is a microscopic view of the surface of the anti-corrosion coating on the palm; FIG. C is a microscopic view of the rough pitted surface of the finger.

### DESCRIPTION OF EMBODIMENTS

In describing the preferred embodiments, specific termi-nology will be resorted to for the sake of clarity. It is to be understood that each specific term includes all technical equivalents which operate in a similar manner to accomplish a similar purpose.

While various aspects and features of certain embodiments have been summarized above, the following detailed description illustrates a few exemplary embodiments in further detail to enable one skilled in the art to practice such embodiments. Reference will now be made in detail to embodiments of the inventive concept, examples of which are illustrated in the accompanying drawings. The accompanying drawings are not necessarily drawn to scale. The described examples are provided for illustrative purposes and are not intended to limit the scope of the invention. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

As used in the description of the inventive concept and the appended claims, the singular forms “a,” “an,” and “the” are intended to include the plural forms as well, unless the context clearly indicates other.

In the description of the present invention, it should be noted that if the specific conditions are not specified in the examples, the conventional conditions or the conditions suggested by the manufacturer shall be followed. If the manufacturer is not indicated on the reagents or instruments used, they are all commercially available conventional products.

The present invention provides a metal material, which comprises the following ingredients in percentage by weight: C≤0.06%, Si≤1.00%, 1.00%≤Mn≤4.00%, P≤0.045%, S≤0.005%, 20.00%≤Cr≤22.00%, 8.50%≤Ni≤10.50%, 1.00%≤Mo≤2.50%, 1.00%≤Cu≤3.50%, 0.20%≤N≤0.30%, with the balance being Fe; the pitting resistance equivalent number (PREN) of the metal material is calculated according to the formula: PREN=Cr %+3.3M0%+16N %, and the result is PREN>30.0%. Specifically, the metal material is selected from at least one of SUS304, SUS316L, SUS317, QN2109, 2507, SUS430 and DC04.

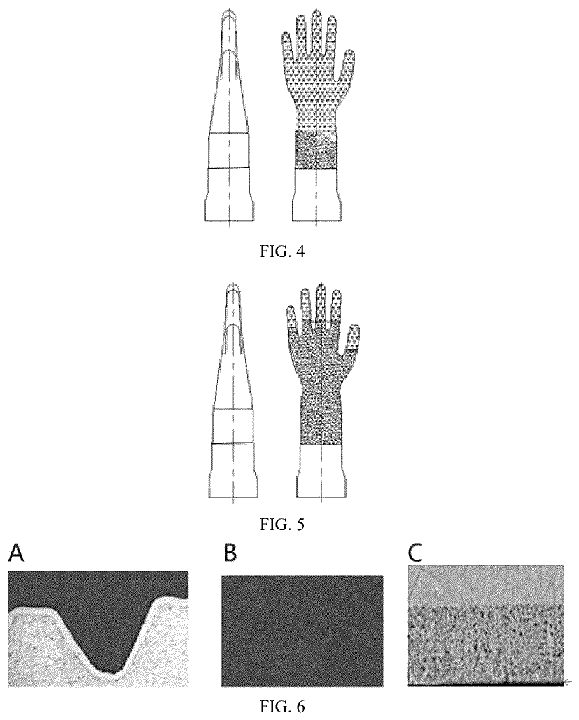

The present invention also provides a method for preparing a metal model by using the metal material, and the metal model consists of a palm 1, an arm 2 and a base 3 (take FIG. 3 as an example, and the structures of the palm, the arm and the base in FIGS. 4 and 5 are the same as those in FIG. 1). The preparation method comprises: preparing the palm 1, the arm 2 and the base 3 in the metal model structure separately to obtain the models of the palm 1, the arm 2 and the base 3, and then connecting the models of the palm 1, the arm 2 and the base 3 to realize the preparation method of the metal model. The obtained metal models are divided into four types: S, M, L and XL, which are consistent with the current models. The structural features are as follows: the integral model is a metal sheet hollow structure with a wall thickness of 0.3-2.0 mm, which is in a continuous streamline shape; except for the opening of the base, other parts of the whole structure are sealed and airtight. The structure is hollow, which can effectively reduce the weight of the model, has the characteristics of lightness and thinness, and ensures the firmness of the structure. After the effective part is impregnated with NBR latex, a liquid-tight and air-tight sealing state can be achieved, thus ensuring that the NBR latex liquid does not penetrate into the mold cavity when the metal model is impregnated with NBR latex. The uniformity of the model wall thickness makes the film-formed NBR products have the same wall thickness and color. The smooth streamline structure ensures that the surface of the product after film formation is smooth and wrinkle-free, and the shape is full. The bottom base has an opening design, which is convenient for the model to be fixed on the fixed seat of the NBR production line. The production line of NBR latex is the prior art, which is not specifically introduced here.

The technical solution of the present invention will be described clearly and completely with the attached drawings and specific examples, but the following examples are only part of the research of the present invention, and are only used to illustrate the present invention, and should not be regarded as limiting the scope of the present invention. Based on this, other examples obtained by those skilled in the art without creative work belong to the scope of protection of the present invention. If the manufacturer is not indicated on the reagents or instruments used, they are all conventional products that are commercially available.

### Example 1

This Example provides a method for preparing a metal model for the production of NBR latex pitted-surface impregnated gloves. The metal material used is SUS316L, and the structure of the metal model is shown in FIG. 3, with the standard L size. The preparation steps are as follows:

Step 1, a palm part was divided into two parts, and a single-piece palm was respectively drawn and formed by using metal plates such as stainless steel, and the drawn mouth is trimmed after forming.

Step 2, the single-piece palms were spliced and the two single-piece palms were connected into an whole palm by laser welding.

Step 3, the connected palms were ground and polished to make the palm part present a complete palm shape, and the wrist end was trimmed to be flat and consistent.

Step 4, the arm part was formed by a welded pipe made of a SUS316L material to achieve the required shape and size.

Step 5, the palm part and the arm part were spliced and connected together by laser welding.

Step 6, the base was welded in the next step; the base was a commercially available product made of SUS430.

Step 7, the whole product was ground and polished, and the welding scar of the welding seam was ground off.

Step 8, the pressurized pitting process was adopted, which includes: using steel shots with a size of 2.0 mm, and continuously sandblasting the product for 50s under the air pressure of 0.8Mpa; shielding other parts of the model by a shielding jig, processing the rough pitted surface of the finger end, the pit size of the rough pitted surface being 1.0-3.0 mm, and the surface roughness being shown in FIG. 1 (obtained by a roughness tester), wherein the finger end was shown in FIG. 1 by reference sign 4.

Step 9, the shielding jig was removed and an overall 60-mesh sand blasting treatment was carried out on the integral model.

Step 10, a metal dense layer with a thickness of 0.03 mm was formed on the surface of the model after sand blasting through passivation treatment of stainless steel, which played an anti-corrosion effect; the specific operation was as follows: the final concentration composition of the passivation solution was: magnesium chloride, 40 g/L; sodium chromate, 40-50 g/L, and water as solvent; the model was immersed in the passivation solution at 80-90° C. for 2-3 min, taken out, and washed with water for several times.

FIG. 6 also shows the interface between palm and finger, the anti-corrosion coating on palm and the surface enlargement effect of the rough pitted surface on finger of the metal model of Example 1, which shows that the pits are uniform, the thickness of the anti-corrosion coating is uniform and the compactness is good.

### Example 2

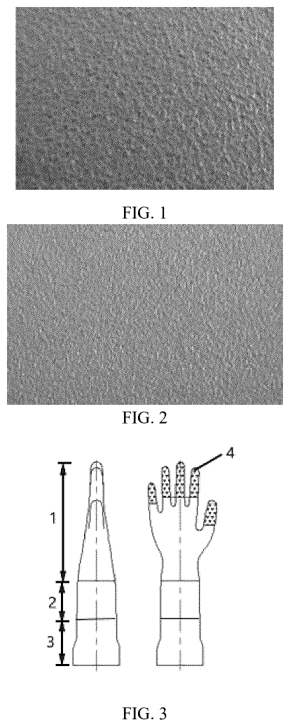

This Example provides a method for preparing a metal model for the production of NBR latex impregnated gloves, which is different from Example 1 in that the structure of the metal model was shown in FIG. 4, and step 8, in which after the other parts of the model were shielded by a shielding jig, the rough pitted surface of the palm was processed, and the arm was a fine pitted surface, wherein the preparation of the rough pitted surface includes: using steel shots with a size of 1.5 mm, and continuously sandblasting the product under the air pressure of 0.7Mpa; the preparation of the fine grained surface includes: using steel shots with a size of 1.0 mm, continuously sandblasting the product for 50s under the air pressure of 0.7Mpa to obtain the fine grained surface with a pit size of 0.1-0.7 mm, and the surface roughness of the fine grained surface was shown in FIG. 2.

### Example 3

This Example provides a method for preparing a metal model for the production of NBR latex pitted-surface impregnated gloves. The metal material used is SUS316L, and the structure of the metal model was shown in FIG. 5, with the standard L size. The preparation steps are as follows:

Step 1, a palm part was divided into two parts, and a single-piece palm was respectively drawn and formed by using metal plates such as stainless steel, and the drawn mouth is trimmed after forming.

Step 2, the upper and lower parts of the model were spliced and the two single-piece palms were connected into a whole palm by laser welding.

Step 3, the connected palms were ground and polished to make the palm part present a complete palm shape, and the wrist end was trimmed to be flat and consistent.

Step 4, the arm part was formed by a welded pipe made of a SUS316L material to achieve the required shape and size.

Step 5, the palm part and the arm part were spliced and connected together by laser welding.

Step 6, the base was welded in the next step; the base was a commercially available product made of SUS430.

Step 7, the whole product was ground and polished, and the welding scar of the welding seam was ground off.

Step 8, the pressurized pitting process was adopted, and after the other parts of the model were shielded by a shielding jig, rough pitted surfaces were formed on the fingers (the structure and parts were the same as those shown in FIG. 3), and fine pitted surfaces were formed on the remaining palms and arms; the preparation of the rough pitted surfaces included: using steel shots with a size of 2.0 mm, and continuously sandblasting the product for 50s under the air pressure of 0.8Mpa to obtain rough pitted surface with a pit size of 0.8-3.0 mm. The preparation of fine pitted surfaces included: using steel shots with a size of 1.5 mm, and continuously sandblasting the product for 50s under the air pressure of 0.7Mpa to obtain fine pitted surfaces with a pit size of 0.2-0.7 mm.

Step 9, the shielding jig was removed and an overall 60-mesh sand blasting treatment was carried out on the integral model.

Step 10, nickel plating was carried out on the model to form a dense coating of 0.05 mm.

Step 11, 60-mesh sand blasting was carried out on the outer surface of the electroplated nickel layer to form a matte surface.

### Example 4

This Example provides a method for preparing a metal model for the production of NBR latex pitted-surface impregnated gloves. The adopted metal material was SUS316L, with a standard L size, and the preparation steps were as follows:

Steps 1 to 9 were the same as those in Example 1.

Step 10, plasma spraying equipment was adopted by plasma spraying, and its processing parameters were as follows: the preheating temperature of the model was 100-130° C., the argon gas inlet was about 35 L/min, the chromium powder feeding amount was 17 g/min, the moving speed of the spray gun was 100 mm/s, the voltage and current was 80V/200A, the power was 35KW, the spraying distance was about 110 mm, and the spraying angle was about 60-80°, forming a corrosion-resistant nano coating of metallic chromium with a thickness of 0.05 mm on the surface of the model in step 11.

The metal models of Examples 1 to 4 can achieve the effects of local rough pitted surface, fine pitted surface and full pitted surface, and form a shallow honeycomb pit effect with dense and tiny convex structures. Furthermore, uniform concave-convex texture can be formed on NBR latex products, which plays a role in increasing surface friction and anti-skid, and the gripping force of NBR latex products is enhanced.

The metal models obtained in Examples 1˜4 were compared in weight with the ceramic model (standard L number) prepared with reference to JC/T2347-2015 Ceramic Glove Mould (Comparative Example 1) and the ceramic model (standard L number) prepared with reference to Example 1 of CN202011054324.5 (Comparative Example 2), and the results are shown in Table 1.

TABLE 1
Weight comparison between metal model and ceramic model

| Model | Example 1 | Example 2 | Example 3 | Example 4 | Contrast 1 | Contrast 2 |
|---|---|---|---|---|---|---|
| Weight (g) | 4.16 | 4.17 | 4.24 | 4.28 | 4.55 | 4.59 |

### Example 5

The L-type metal model of Example 1 and the ceramic model of the same specification of Comparative Example 1 were tested on the NBR latex production line, and the specific preparation process is not described in detail here, which is the existing technology. The computer test data is provided by Anhui Yingke Medical Products Co., Ltd.

The production performance comparison between the metal hand mold of Example 1 and the traditional ceramic hand mold is shown in Table 2:

TABLE 2
Comparison of production performance

| Item | Ceramic model | Metal model |
|---|---|---|
| Duration of use | 3-6 months | 3-6 years |
| Heat conduction | 7 minutes (before the | 2 minutes (allowing the |
| time | mold temperature reaches | mold temperature to |
| | 180° C.) | reach 180° C.) |
| Glove gelation | 7-9 minutes (oven | 2-3 minutes (oven |
| time | temperature; 210° C.) | temperature; 210° C.) |
| Wash | Stripping requires pickling | Easier to demould |
| | and alkali immersion | |
| Energy | Slow heat conduction, | High efficiency, which |
| conservation | which wastes energy | can save 60% energy |
| Fracture | 1.3 (plasticizer dosage | 1.3 (plasticizer dosage |
| causticity (KG) | 90%) | 110%) |
| Tension value | 12 (plasticizer dosage 90%) | 12 (plasticizer dosage |
| | | 110%) |
| Elongation rate | 400 (plasticizer dosage | 400 (plasticizer dosage |
| (%) | 90%) | 110%) |
| Viscosity | 110 CPS (material | 70 CPS (material |
| | temperature 40° C.) | temperature 40° C.) |

In Table 2, the reference standards for testing fracture hardness, tensile strength, elongation rate and viscosity value are: GB 7543-2006 Disposable sterilized rubber surgical gloves, and other reference standards include: GB 10213-2006 Disposable medical rubber examination gloves, GB 24786-2009 Disposable PVC medical examination gloves, GB/T528-2009 Determination of tensile stress-strain properties of vulcanized rubber or thermoplastic rubber, SNT 0678-2008 Inspection rules for disposable medical rubber inspection gloves for import and export.

Table 2 shows that the metal hand mould obtained by the present invention has the advantages of longer service life, faster heat conduction, more convenient cleaning, lower volatilization rate of raw materials, lighter weight and better mechanical properties compared with ceramic hand moulds, and more importantly, its preparation process is more energy-saving.

### Example 5

The metal models of Examples 1-4 were tested by 3% sodium hypochlorite solution immersion test, nitrile pickling test, pressure resistance test and salt spray test respectively, and the results were as follows:

1) Detection of immersion in 3% sodium hypochlorite solution: At 30° C., the metal models of Examples 1-4 were completely immersed in 3% sodium hypochlorite solution for immersion test for 48 hours, and no corrosion occurred in all samples. The sandblasting thickness was reduced by 2 microns in Example 1, 2 microns in Example 2, 3 microns in Example 3 and 3 microns in Example 4.

2) Nitrile pickling detection: at 30° C., the metal models of Examples 1-4 were soaked in nitric acid with pH=1 for 360h, until no rust spots appeared on the finger pitted surfaces and between fingers; no rust spots appear on the non-finger pitted surfaces and between fingers.
3) Anti-pressure detection: the metal models of Examples 1 to 4 were tested by an electronic universal testing machine, and the pressure was 700-800 KG, and the products did not deform.

4) Salt spray test: at 30° C., the metal models of Examples 1 to 4 were subjected to salt spray test for 360h according to Salt Spray Test of Artificial Atmosphere Corrosion Test, and no rust spots appeared on the surfaces of all metal models and between fingers.

The above-mentioned Examples only express several Examples of the present invention, and their descriptions are more specific and detailed, but they cannot be understood as limiting the patent scope of the present invention. It should be pointed out that for those skilled in the art, without departing from the concept of the present invention, a number of variations and improvements can be made, which are within the scope of protection of the present invention. Therefore, the scope of protection of the patent of this invention shall be based on the appended claims.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for case of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state.

The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

The invention has now been described in detail for the purposes of clarity and understanding. However, those skilled in the art will appreciate that certain changes and modifications may be practiced within the scope of the appended claims.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

What is claimed is:

1. A metal material, wherein,
said metal material comprises the following ingredients in percentage by weight: C≤0.06%, Si≤1.00%, 1.00%≤Mn≤4.00%, P≤0.045%, S≤0.005%, 20.00%≤Cr≤22.00%, 8.50%≤Ni≤10.50%, 1.00%≤Mo≤2.50%, 1.00%≤Cu≤3.50%, 0.20%≤N≤0.30%, with the balance being Fe; and a pitting resistance equivalent number (PREN) of the metal material is calculated according to a formula: PREN=Cr %+3.3M0%+16N %, and a result is PREN≥30.0%.

2. A method for preparing a metal model comprising a palm, an arm and a base, wherein said method comprises: preparing said palm, said arm and said base separately to obtain models of said palm, said arm and said base, and then connecting the models of said palm, said arm and said base to realize preparation of said metal model.

3. The method according to claim 2, comprising the following steps:
Step 1, compounding the ingredients of said metal material according to claim 1 to prepare a metal coil, cutting said metal coil into sheets, and respectively forming said sheets into single-piece palm models and an arm model by stamping and stretching; and
Step 2, connecting two pieces of said single-piece palm models in a welding mode to form a complete palm model; and
Step 3, connecting said complete palm model and said arm model by welding; and
Step 4, connecting said base with the model obtained in step 3 by welding to form an integral model; and
Step 5, processing the palm part of said integral model to form a pitted surface; and
Step 6, carrying out surface treatment on said integral model with the pitted surface to form an anti-corrosion and wear-resistant layer.

4. The method according to claim 3, wherein said base is made of SUS430.

5. The method according to claim 3, wherein said pitted surface comprises a rough pitted surface or a fine pitted surface, and said pitted surface is formed by a pressurized pitting process or an etching process.

6. The method according to claim 5, wherein a pit size of said rough pitted surface is 0.5 mm to 3.0 mm, and a pit size of said fine pitted surface is 0.1 to 1.0 mm.

7. The method according to claim 5, wherein said pitted surface is only located at finger tips of the palm.

8. The method according to claim 5, wherein said pitted surface is the whole palm part.

9. The method according to claim 8, further comprising: after processing said pitted surface of said palm model, carrying out sand blasting treatment on the obtained integral model, preferably, using 60-150 mesh sand.

10. The method according to claim 9, wherein an anti-corrosion and wear-resistant layer is formed on the surface of said integral model by one of the following methods: passivation, immersion, spraying and electroplating; and a thickness of said anti-corrosion and wear-resistant lay is 0.01 mm to 0.12 mm.

11. The method according to claim 10, wherein a final concentration composition of a passivation solution adopted in said passivation is: magnesium chloride, 30-40 g/L; and
sodium chromate, 40-50 g/L, and water as solvent; and
before passivation, said metal model is washed with a pickling solution; and
said pickling solution adopts at least one of 30-40% nitric acid solution, 10-15% hydrofluoric acid solution and 10-15% sulfuric acid solution by mass concentration.

12. The method according to claim 10, wherein a reagent used in said infiltration is nano-ceramic coating; and
a working temperature of an infiltration process is 15-30° C.

13. The method according to claim 10, wherein said spraying is plasma spraying, and an anti-corrosion material adopted is one of nickel, nickel alloy, chromium and chromium alloy.

14. The method according to claim 10, further comprising: said electroplating method being specifically nickel plating or chromium plating.

15. The method according to claim 14, further comprising: after forming said integral model in step 4, grinding and polishing a patchwork seam of said integral model and trimming a port of a base part to make the port of said base part present a flat and consistent state.

16. The method according to claim 15, wherein said welding is laser welding.
